(19) United States
(12) Patent Application Publication
(10) Pub. No.: US 2006/0166724 A1
(43) Pub. Date: Jul. 27, 2006

(54) Golf putt measuring device

(75) Inventor: Vartan Toroussian, Montreal (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Daito Precision Inc., Ville St-Laurent (CA)

(21) Appl. No.: 11/215,566

(22) Filed: Aug. 29, 2005

(30) Foreign Application Priority Data
Jan. 26, 2005 (CA) 2,494,462

(51) Int. Cl. A63F 13/00

(52) U.S. Cl. 463/1

(57) ABSTRACT

A portable device for measuring aspects of a moving projectile (such as a golf ball) in a sporting activity is provided. The device produces calculations from events it detects. The device comprises a set of detectors in a spaced relationship for detecting movement of the projectile across the device; a display; a set of input keys; a microprocessor controlling operation of the detectors, the display and the input keys; and software operating on the microprocessor for controlling operation of the microprocessor and for producing the calculations based on data received from the detectors and the input keys. In the software, the calculations include: a calculation producing an estimated distance travelled by the projectile, a calculation producing an estimated force imparted on the projectile and a calibration of the estimated distance using a measured distance of the projectile compared against the estimated distance.

### FIELD OF THE INVENTION

The present invention relates to a device for making measurements and calculations for a sporting activity, in particular, a device used for the game of golf.

### BACKGROUND

Golf is a sport enjoyed by many enthusiasts. Although several physical and emotional skills are needed to enjoy golf, one of the more critical skills is putting a golf ball into the target hole.

Good putting involves good technique and an appreciation for the conditions of the putting green. Although many people practice putting at home in a hallway or in a carpeted room, the actual conditions on a green provide a vastly different putting environment. For example, the type and condition of the grass on the green influence the speed and path of the golf ball. Also, a slope on the green affects the speed of the ball. Existing electronic putting distance calculation devices lack calculation, calibration and training features.

There is a need for a device which provides putting information which addresses the deficiencies in the prior art.

### SUMMARY

In a first aspect, a portable device for measuring aspects of a moving golf ball is provided. The device produces calculations from events detected on the device. The device comprises a set of detectors located on at least one side of the device in a spaced relationship for detecting movement of the golf ball across the device; a display; a set of input keys; a microprocessor in the device controlling operation of the set of detectors, the display and the input keys; and software operating on the microprocessor for controlling operation of the microprocessor and for producing the calculations based on data received from the set of detectors and the input keys. In the software, the calculations include: a calculation producing an estimated distance travelled by the golf ball, a calculation producing an estimated force imparted on the golf ball and a calibration of the estimated distance using a measured distance of the golf ball compared against the estimated distance.

In the device, the calibration of the estimated distance may relate to a friction calibration for a green upon which the golf ball is putted.

In the device, the software may further provide a slope calibration of the estimated distance based on a slope for the green upon which the golf ball is putted.

In the device, the software may further provide a consistency mode allowing successive golf putts to be measured and compared.

In the device, the software may further determine a green speed of the green, based on a distance estimated by the device which is travelled by the golf ball when putted across the device with a predefined force.

The device may further comprise a putting module to selectively impart on the golf ball the predefined force.

In the device, a condition of the green may be provided to the software before the green speed is determined.

In the device, the calculation producing an estimated distance travelled by the golf ball may utilizes the slope calibration, the friction calibration, a calculated speed of the golf ball and a gravity co-efficient.

In the device, the calculated speed may utilize time readings provided from at least two detectors operating when the golf ball is putted across the device.

The device may be adapted to detect said golf ball moving by said device either from left to right or from right to left.

In a second aspect, a portable device for measuring aspects of a sporting activity, producing calculations from events detected on the device is provided. The device comprises: a set of detectors located on at least one side of the device in a spaced relationship for detecting movement of a projectile associated with the sporting activity across the device; a display; a set of input keys; a microprocessor in the device controlling operation of the set of detectors, the display and the input keys; and software operating on the microprocessor for controlling operation of the microprocessor and for producing calculations based on data received from the set of detectors and the input keys. The calculations include: a calculation producing an estimated distance travelled by the projectile, a calculation producing an estimated force imparted on the projectile and a calibration of the estimated distance using a measured distance of the projectile compared against the estimated distance.

In other aspects various combinations of sets and subsets of the above aspects are provided.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes).

FIG. 1 is a perspective view of an exemplary device that incorporates an embodiment of the invention in use;

FIG. 2 is another perspective view of the device of FIG. 1;

FIG. 3 is a block diagram of selected components of the device of FIG. 1;

FIG. 4 is a block diagram of a detection circuit associated with the device of FIG. 1;

FIG. 5 illustrates a series of three exemplary outputs produced on a display of the device shown in FIG. 1;

FIG. 6 is a flow chart of the operation of software operating on the device as shown in FIG. 1;

FIG. 7A is a block diagram of a ball launcher associated with the embodiment of the device as shown in FIG. 1; and

FIG. 7B is a block diagram of another ball launcher associated with the embodiment of the device as shown in FIG. 1.

### DETAILED DESCRIPTION

The description which follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

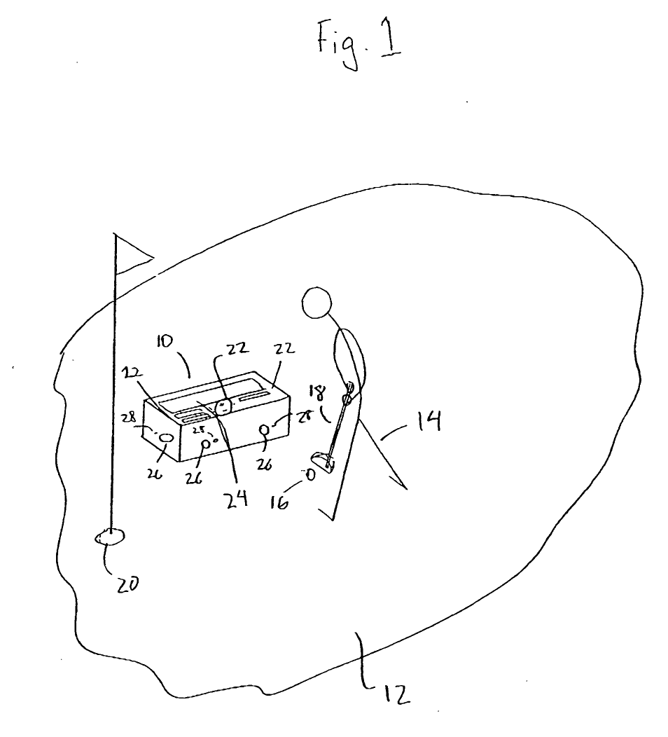

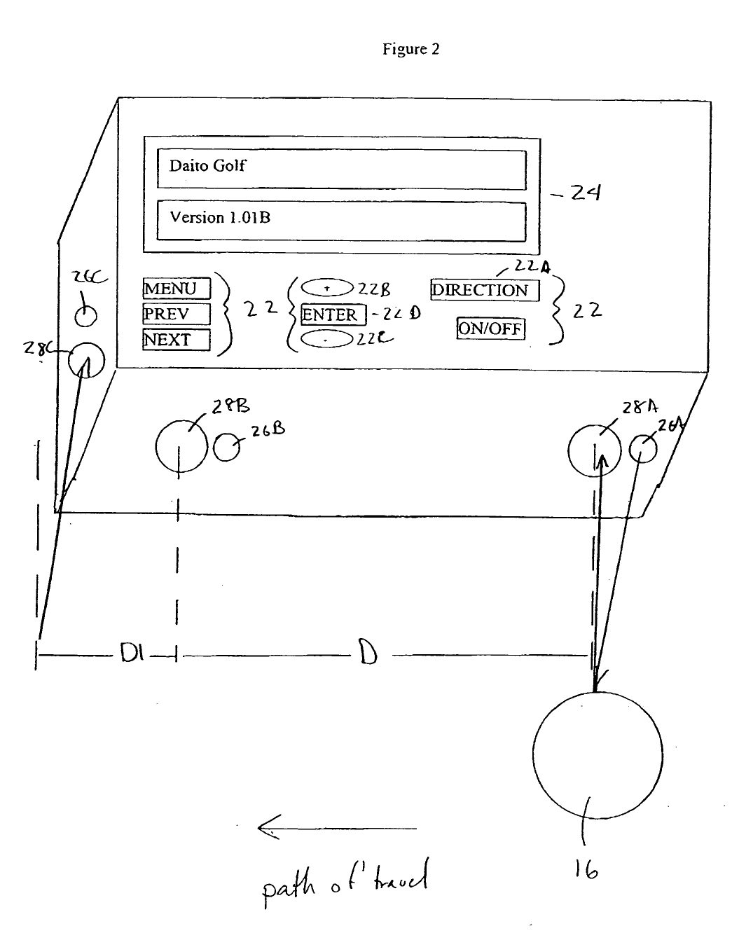

FIGS. 1 and 2 illustrate a device 10 in use on a putting green 12. Therein, golfer 14 is attempting to putt golf ball 16 using putter 18 into hole 20. Golf ball 16 may be any golf ball and is typically a commercially available golf ball and putter 18 may be any putter commercially available putter, such as the Virtuoso (trade-mark of Daito Golf, Inc.) putter, or a custom-made putter

Briefly, to calculate a distance travelled by a golf ball, golfer 14 places device 10 on the ground near golf ball 16 and in parallel to a path of intended travel of the golf ball. Then, golfer 14 activates device 10 and uses its input keys to cause device 10 to enter one of its operating modes, such as a putt distance estimating mode. Display 24 provides a text and graphical messages to indicate the current mode of device 10 and any calculated distances or measurements. Signal transmitters 26 and detectors 28 provide a detection mechanism for the travel of the golf ball. When device 10 is set and ready to estimate a distance for a putt, golfer 14 putts golf ball 16 by device 10 (again, along a path generally parallel to the front face of device 10), so that golf ball 16 travels across detectors 28. As will be described in further detail below, as golf ball 16 travels across the green 12 and by detectors 28, device 10 uses information provided by the detectors to calculate a speed and to estimate a distance that golf ball 16 will travel. Results of the calculations are shown on display 24.

Device 10 also has the flexibility of allowing putts to be measured moving from the left to right by its detectors and moving from the right to left. This facilitates use of device 10 by left-handed and right-handed putters. Direction of the putt (either from left to right or from right to left) for the device is toggled by the “direction” key 22A. Direction of the putt (either from left to right or from right to left) is toggled by the “direction” key 22A. In this regard, the arrangement and number of detectors may be provided such that there is a symmetrical pattern of transmitters and detectors about the vertical middle of device 10, facilitating use of device 10 whether a putt is made from the left to the right, or vice versa. Once the direction is set, the software operating on device 10 causes display 24 to show an indicator for the set direction. Depending on the setting of the “direction” key 22A, the software accommodates for the expected sequence of triggering of detectors and timers and adjust its variables and any necessary calculations accordingly.

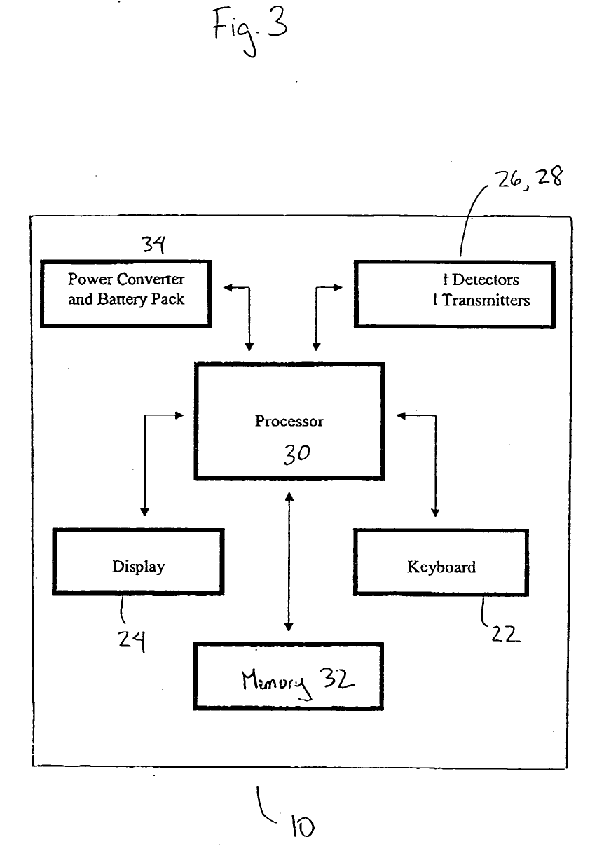

Referring to FIG. 3, details of hardware and software components in device 10 are provided. As noted above, device 10 comprises input keys 22, display 24 which is preferably a graphic Liquid Crystal Display (LCD), signal transmitters 26 and signal detectors 28. Controlling operation of the components is microprocessor 30. Memory 32 is also provided. Although memory 32 is shown as a single device, it includes non-volatile memory and volatile memory and may be implemented as one or more different devices. In the embodiment, software which is operable on processor 30 is stored in non-volatile memory portion of memory 32. The software embodies an algorithm which controls the operation of device 10, reacting, in part, to inputs received from input keys 22 and detectors 28. Further detail on operation of the algorithm and software are provided below. Power source 34 provides power for processor 30 and all other powered components and circuits in device 10. Power source 34 may be a battery pack, such as a 9V battery, providing the required voltages for the components. Alternatively, power source 34 may convert an AC signal (e.g. from a typical household power outlet) and convert is to a useable voltage for device 10.

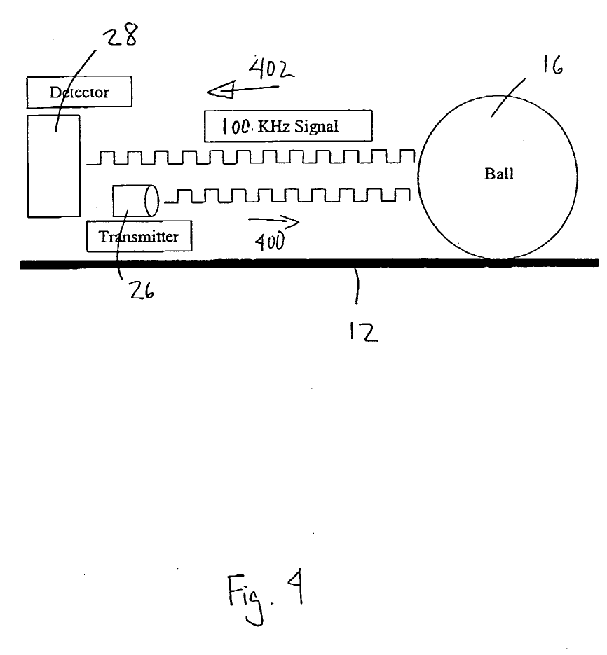

Referring to FIGS. 2 and 4, the embodiment makes calculations and presents results based on a calculated time that it takes golf ball 16 to travel a predefined distance. Using the distance and time values, the speed of golf ball 16 can be calculated as well as an estimated distance of travel. To measure the time that golf ball 16 travels, device 10 has two or more detectors 28 located at predetermined locations on the sides device 10. As shown in FIG. 2, two detectors 28 are located on the front face of device 10 and are positioned to be a distance D apart from each other (measured along the bottom of device 10).

In the embodiment, detectors 28 and transmitters 26 use high frequency radio signals. For accuracy considerations, one transmitter 26 is associated with one detector 28. The two components are used as a transmitter/detector pair. In other embodiments, depending on the signal pattern dispersed by a transmitter and the accuracy intended for a distance calculation, fewer or more transmitters may be used compared with the number of detectors.

In the embodiment, a transmitter 26/detector 28 pair operates as follows. Once device 10 is activated to estimate a distance of a putt, selected transmitter/detector pairs on device 10 are activated. Referring to FIG. 2, in the typical operation of device 10, the two pairs bounding distance D on the front face of device 10 are activated. In the embodiment D is 4.47 inches (approximately 0.1135 m). In each pair, the transmitter emits a radio frequency signal perpendicular to the face of the device. Although almost any radio frequency and signal type may be used, the transmitter emits a directed periodic 100 kHz frequency signal. Detector 28 is designed to detect reception of that signal when it is received thereat. As shown in FIG. 4, first, signal 400 is emitted from transmitter 26. When golf ball 16 crosses the path of emitted signal 400, the signal is reflected from the surface of the golf ball and at a certain point, the reflected signal is reflected directly back towards device 10 as reflected signal 402. This reflected signal 402 is received and detected by the corresponding detector 28. Once the detector receives the reflected signal, the software notes the reception of the signal and the time of reception. In other embodiment, other technologies and types of transmitter/detector pairs may be used, including those using optical, infrared and ultrasonic signals.

Referring to FIG. 2, in operation, the following description is provided for golfer 14 putting golf ball 16 from the right to the left of device 10. As such, golf ball 16 will first pass by detector 28A/transmitter 26A pair on the right side of the front face of device 10. Thereafter, golf ball 16 will then pass by detector 28B/transmitter 26B pair on the left side of the front face of device 10. As golf ball 16 passes a detector 28, device 10 marks a time associated with the pass. The algorithm waits for both detectors 28A and 28B to indicate that the ball has passed their detection ranges. A timeout limit is also provided by the device in order to prevent device 10 from waiting for a signal from one or both of the detectors. Alternatively, when the right detector senses golf ball 16, it may start an internal timer which is stopped when the left detector senses golf ball 16.

Once both detectors have recorded a time, a difference for the detected times is calculated by the algorithm. Thereafter, the algorithm uses the known distance between the two detectors, to calculate a speed for the golf ball and then uses the speed to estimate a distance for the putt.

Additional detector/transmitter pairs may be provided along the sides of device 10 to provide further time and distance data for the path of golf ball 16. Also, other embodiments may have a detector 26C/transmitter 28C pair located on a side of device 10, which is aimed towards the front of device 10, to detect when a golf ball 16 moves through location D1. This additional time and space data can be used to refine the speed and distance calculations for the golf ball. Additional detectors and transmitters may be placed on the right side of device 10.

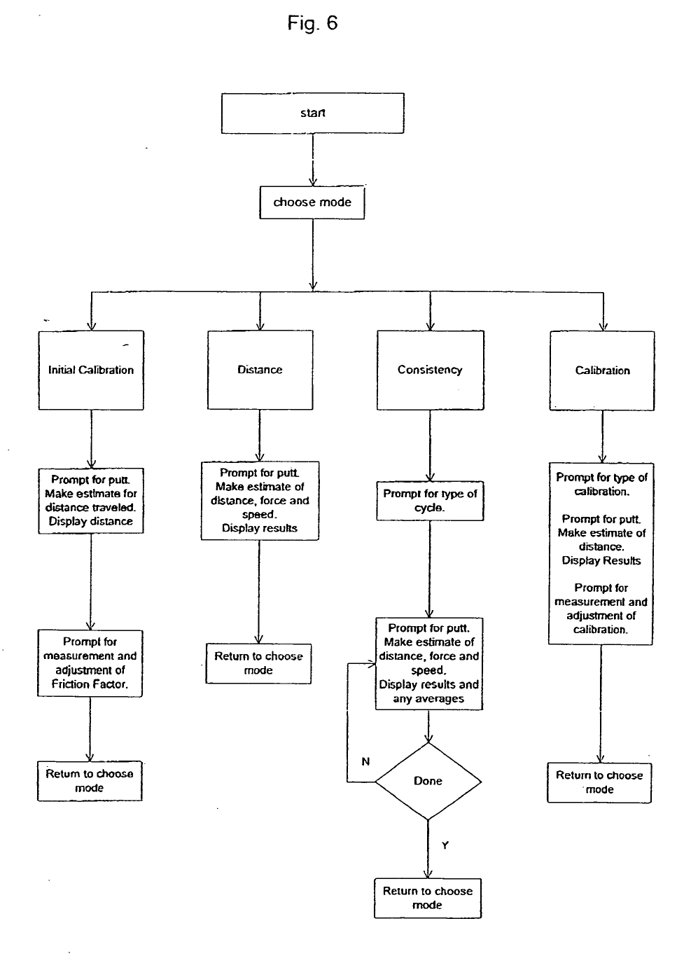

Referring to FIGS. 2 and 6, device 10 operates in several modes including: an “initial calibration” mode, a “distance” mode to calculate a distance for a putt; a “consistency” mode to track the distance consistency of a set of putts; a “calibration” mode to calibrate a distance estimation for the friction and slope of the putting surface; and a “green speed calculation” mode. After device 10 is activated, the software generates a display message on display 24, inviting the user to select a mode by pressing the “+” button 22B and “−” button 22C to toggle through the available modes. As the user toggles through the modes, display 24 shows the mode which may currently be selected. Once the desired mode is currently selectable, the user selects “enter” key 22D to activate the mode. Each mode is described in turn

For the “distance” mode, the following steps are executed. After the user places device 10 in the “distance” mode, the software generates data and control signals for a message on display 24 indicating that the golfer may putt a golf ball. The message may also remind the golfer as to the initial ideal placement and trajectory of the golf ball relative to device 10. In order to obtain an accurate reading of the initial speed of the golf ball, it is preferable to position the golf ball at a position just to the right of the right detector 28A and then putt the golf ball along a path parallel to the front face of device 10, past left detector 28B.

After the golfer putts the ball, as it moves across both of detectors 28A and 28B, each detector/transmitter pair indicates to device 10 their time of detection. Based on the two times of detection (or the elapsed time between the two detection events) and the known distance “D” between the two detectors, the software on device 10 calculates the speed of the ball using Equation 1:

$$Speed of ball = \frac{Distance D}{Time noted by detector 28 B - time noted by detector 28 A} \qquad ( Equation 1 )$$

Then, the software calculates the distance that the ball will travel using Equation 2:

$$Distance of ball = \frac{0.5 ⨯ Sc ⨯ Fc ⨯ A ⨯ Speed of {Ball}^{2} ( from Eq . 1 )}{\begin{matrix}G ⨯ [ Friction Factor + \\ tan ( angle of green ) ]\end{matrix}} \qquad ( Equation 2 )$$

where:
“Sc” is a Slope Calibration value, initially set to 1.0, but adjustable by settings provided by the golfer, per Equation 4, described below.
“Fc” is a Friction Calibration value, initially set to 1.0, but adjustable by settings provided by the golfer, per Equation 5, described below.
“A” is a correction factor, initially set at 1. If it is determined that the calculated distance is not accurate, then A may be set to a value to correct the inaccuracy. E.g. if the calculated distance was identified to be 10% too short, then A would be set to 1.10.
“G” is an acceleration constant for gravity (9.8 m/s²)
“Friction factor” (FF) is a defined friction factor associated with the current putting surface calculated in the “initial calibration mode”
“Angle of green” is a defined slope associated with the current putting surface. For a level green, the value is 0.

In the embodiment the Friction Factor (FF) is a variable which is set at the time of manufacture or alternatively at the initial time of use. In the embodiment, for Equation 2 as presented, FF can be set to a value within the range of 0.0001 to 0.2. In use, it is set to an initial value, such as 0.1. The FF is used to initially calibrate the calculations of the distance estimated by Equation 2 based on whether the putting surface has a low, medium or high amount of friction (due in part on conditions at and around the putting green, including, for example, the type of grass, the present humidity and the green hardness).

To set a value for FF, device 10 is placed in “initial calibration” mode and the software produces a request on display 24 for the golfer putt a golf ball for a distance measurement. Once the ball is putted and device 10 provides an estimated distance using Equation 2, the golfer measures the actual distance travelled by the golf ball. Next, if the actual distance is lower than the estimated distance, then FF is adjusted upward by the software by a predetermined incremental amount. In one embodiment, the “+” key 22B is successively pressed to incrementally adjust FF higher. Similarly, if the actual distance is higher than the estimated distance, then the FF is adjusted downward by the software as the user successively presses the “−” key 22C to incrementally adjust FF lower. If necessary, successive putts are made with their distances measured and the initial calibration process is repeated. Once FF is calibrated, its value is saved by pressing the “enter” key 22D and the saved value is used by the software for all calculations for Equation 2, until its next adjustment.

Turning back to the “distance” mode, after the distance of a putted golf ball is calculated using Equation 2, the software calculates the force imparted on the ball using Equation 3:
Force=½×B×ball mass×Speed of Ball²(from Eq. 1) (Equation 3)
where:
“B” is a correction factor, initially set to 1. If it is determined that the calculated force is not accurate, then B may be set to a value to correct the inaccuracy. E.g. if the calculated force was identified to be 10% too little, then B would be set to 1.10.
“ball mass” is a stored variable representing the mass of the golf ball in grams. USGA rules specify that the mass of a golf ball should not exceed 1.620 ounces (approximately 0.04593 kg). It will be appreciated that in other embodiments, device 10 has an input routine allowing the user to enter a specific ball mass for use by the software.

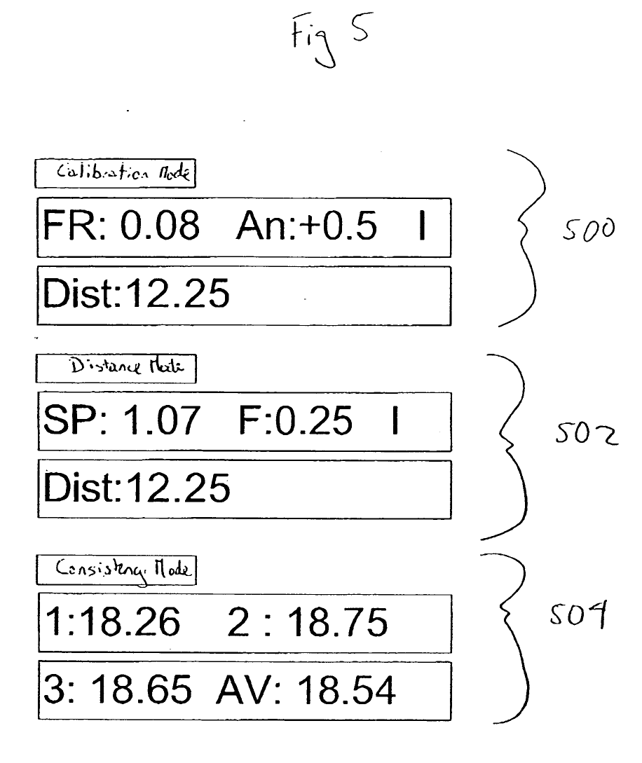

Referring to FIG. 5, display 502 shows a typical information screen produced by device 10 and shown on display 24, where “SP” shows the speed calculated, “F.” shows the force calculated and “Dist.” shows the calculated (i.e. estimated) distance. All values are displayed to the user and are stored as a current set of data. The software can display results in metric (SI), e.g. m/s, km/h and imperial units (feet/s, miles/hr). Simple, known mathematical conversions may be used to express the results in various units

As noted earlier, device 10 has direction key 22A which allows the golfer to set the direction of the putt (either right to left across device 10 or vice versa). As such, software on device 10 makes adjustments to the calculations depending on the direction selected. If the direction is set to putt from left to right, then when calculating Equation 1, the time associated with detector 28A is subtracted from the time associated from detector 28B. If the direction is reversed, then the time associated with detector 28B is subtracted from the time associated from detector 28A. Other mathematical steps, such as taking an absolute value of any difference may be used. Such adjustments are made by the software in other calculations, as necessary.

Turning now to the “consistency” mode, device 10 measures, tracks and displays the distance calculated for a recent set of putts. The golfer can use the “consistency” mode as a training tool to help the golfer obtain distance consistency for putts. In particular, once the “consistency” mode is set and device 10 is ready, device 10 prompts the golfer to make a putt. After the golfer makes a putt, the software calculates an estimated distance, force and velocity for the putt, as per the “distance” mode. However, in the “consistency” mode, device 10 then prompts the golfer to make a second putt. The golfer then makes a second putt attempting to cover the same distance as the first putt. After reading the time data for the second putt, device 10 calculates the distance, force and velocity of the second putt, and then calculates an average distance, force and velocity for the two putts. The results of each putt and the averages are shown in display 24. Device 10 then prompts the golfer to make another putt. After that putt, the calculated values are stored and the average calculations are updated and displayed. For each putt in the recent set of putts, the golfer can use device 10 to track a putt's distance, force and velocity. In one embodiment, the mode uses a set number of putts, for example three putts, to make an averaging calculation. In other embodiments, the number of putts is set by the golfer through the a programming menu on device 10; alternatively, device 10 may allow an unrestricted number of puns, by prompting the golfer after each putt as to whether a next putt is to be added.

As shown in FIG. 5, representative screen shot 504 illustrates results presented on display 24 during the operation of the consistency mode.

Turning now to the “calibration” mode, device 10 allows the golfer to make separate calibrations to the calculations made by device 10 according to a slope present on the putting green and according to a friction value of the putting green.

As defaults, both the angle calibration and the friction calibration are set to 0, i.e. there is no slope on the putting green and there is nominal friction associated with the putting green.

The golfer uses device 10 to calibrate the green angle as follows. First device 10 is placed on a putting green at a location having a slope. Next, device 10 is placed in the “calibration” mode, where initially, the software waits for the golfer to make a putt for measurement. After the golfer makes the putt, device 10 calculates and displays an estimated distance that the ball was expected to travel. However, with the ball being putted on a slope, the ball may go further or shorter than the estimated distance, depending on whether the slope is downhill or uphill. Next, the golfer measures the actual distance travelled by the putt. (In other embodiments, another measuring system may be provided, using known IR and ultrasonic distance finding devices incorporated into device 10.) Finally, to calibrate the slope factor, device 10 prompts the golfer to provide device 10 with that actual distance. In the mode, device 10 provides entry of the actual distance by having the user successively press the “+” key 22B and the “−” key 22C as appropriate. As either key is pressed, device 10 displays an adjusted distance on display 24. When the adjusted distance shown is close to the actual distance, the golfer submits the value to device 10 by pressing the “enter” key 22D. Once the value of the actual distance is entered, device 10 calibrates distances for putts for that slope using a ratio of:

$$Slope Calibration ( Sc ) = \frac{Adjusted Distance}{Estimated Distance} \qquad ( Equation 4 )$$

The value of Sc may be inserted into Equation 2, as noted earlier. It will be appreciated that Sc can be set indepedently of the value of the “Angle of Green” value set in Equation 2. In other embodiments, other adjustment factors may be utilized in Equation 4.

It another implementation of the slope calibration, device 10 may have a tilt-meter, mercury switch or another device built therein which provides an indication of an incline present when device 10 is situated on the green. The data from the tilt-meter can be used to determine a slope calibration.

Similarly, device 10 allows the golfer to calibrate for the friction of the green as follows. First device 10 is placed on a putting green at a flat, unsloped location. Next, device 10 is placed in the friction calibration mode, where initially, device 10 waits for the golfer to make a putt to measure. When the golfer makes the putt device 10 calculates and displays an estimated distance that the ball was expected to travel with nominal friction. However, with the ball being putted on a surface which has a different friction factor, the ball may go further or shorter than the expected distance, depending on whether the friction factor is more or less than the nominal friction factor. Next, the golfer measures the actual distance travelled by the putt. (Again, in other embodiments, device 10 may measure the distance.) Finally, to calibrate the friction factor, device 10 prompts the golfer to provide device 10 with that actual distance. In the mode, device 10 provides entry of the actual distance by having the user successively press the “+” and “−” keys 22B and 22C as appropriate. As either key is pressed, device 10 displays an adjusted distance on display 24. When the adjusted distance is close to the actual distance, the golfer submits the value to device 10 by pressing the “enter” key 22D. Once the value of the actual distance is entered, device 10 calibrates all distances calculated for that friction using a ratio of:

$$Friction Calibration ( Fc ) = \frac{Actual Distance}{Estimated Distance} \qquad ( Equation 5 )$$

The value of Fc may be inserted into Equation 2, as noted earlier. It will be appreciated that Fc can be set indepedently of the value of the FF value also set in Equation 2. In other embodiments, other adjustment factors may be utilized in Equation 5.

Device 10 allows for the use of the slope calibration factor and the friction calibration factor separately and together. For example, Equation 3 may utilize the determined friction and slope factors in place of the corresponding values shown in FIG. 3. Also, the factors may be used to modify the adjustment factor A in Equation 2 and factor B in Equation 3.

As shown in FIG. 5, representative screen shot 500 illustrates results presented on display 24 during the operation of the calibration mode.

It will be appreciated that device 10 may be used on different putting greens, having various slopes and contours thereon. In addition, a green may have different types of grass (e.g. bent grass, Bermuda grass) which affects the roll of a putted ball.

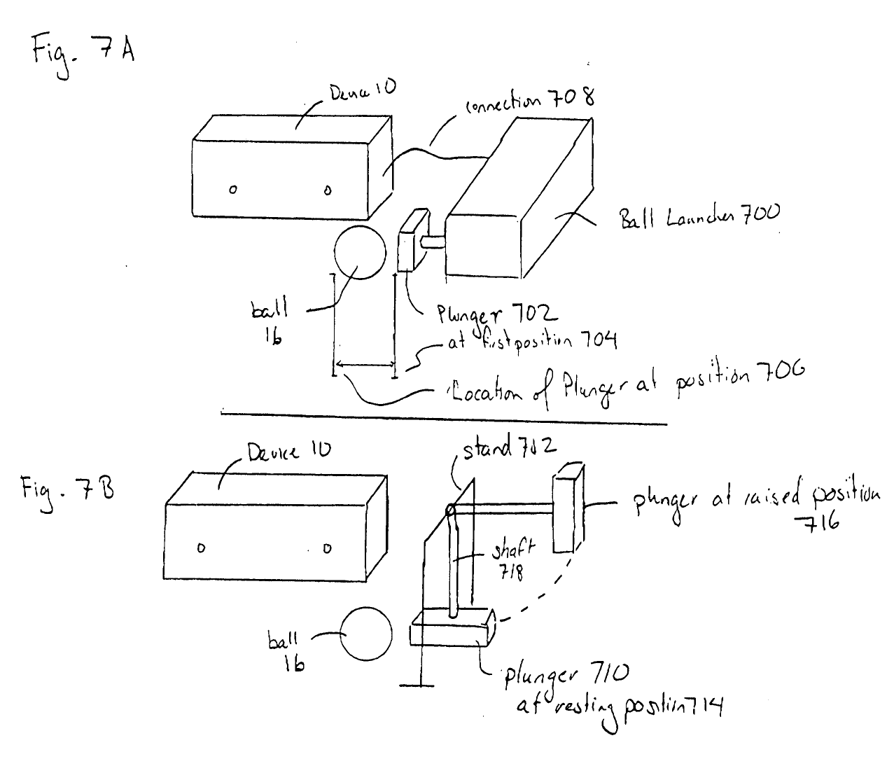

Referring to FIG. 7A, further detail is provided on the “green speed calculation” mode. Therein, device 10 measures and estimates a green speed for a green, similar to a Stimpmeter reading.

As is known in the art of golf, a Stimpmeter is a three-foot long bar having a groove running along its length. In use, the bar is initially laid flat on a green with a golf ball is placed at one end of the bar. Next, that end is raised from the green with the opposite end remaining on the ground. As the bar is raised, eventually, the incline of the bar causes the ball can roll downward along the bar in the groove, off the end of the bar on the ground and across the green. The distance travelled by the ball on the green indicates the speed of the green.

To measure the speed of a green, the Stimpmeter can be used to launch a ball across a green, with the distance travelled by the ball being measured by device 10 to indicate the speed of that green.

However, the embodiment provides other methods of measuring the green speed. In particular, referring to FIG. 7A, the speed of a green is measured using device 10 and ball launcher 700 attached thereto. Ball launcher 700 is an electromechanical device having plunger 702 which selectively moves from a first set position 704 through to a second position 706 with a predetermined force. When in use, plunger 702 is moved to set position 704 with a golf ball placed in front of the plunger 702. Device 10 then selectively activates plunger 702, causing it to move to second position 706 and strike the ball. Alternatively, plunger 702 may be activated independently by launcher 700. When the ball is struck, its travelled distance is measured by device 10, thereby providing a green speed measurement. Plunger 702 may be powered by a solenoid, a spring on the shaft of the plunger or any other mechanical or electromechanical device known to those skilled in the art. The force imparted by plunger 702 may be set at one predefined force level or may be set at one of a series of adjustable forces. The variability of the force can depend on the size of the solenoid, spring or other electromechanical elements controlling movement of plunger 702. The setting of the force is controlled by software in device 10 implementing a green speed algorithm. Alternatively, the setting of the force may be adjusted separately through launcher 700. For example a control knob may be provided on launcher 700 connecting to a control arrangement in launcher 700. In one embodiment, one force level is the force required to propel the ball at the same speed as a ball rolling off a Stimpmeter when used as described earlier. Ball launcher 700 is connected to device 10 through wire connection 708. Power for ball launcher 700 is also provided by device 10.

Referring to FIG. 7B, in other green speed embodiments, a plunger 710 may be pivotally mounted to a stand 712 similar to a swing mounted to a swing set. As such, the plunger 710 may be raised from a resting 714 position and pivoted to a raised position 716 at a fixed height, and then released. Gravity then pulls the plunger downward and it pivots through a resting position 714, imparting a force on the golf ball, propelling it across device 10. Once the ball is launched, device 10 measures the distance travelled by ball 16 as described earlier. The weight of plunger 710, length of its shaft 718 and height of raised position 716 all affect the amount of force applied to the golf ball. It will be appreciated that other types of plungers, hammers and launchers may be used as a putting module for the green speed measuring mode.

In the green speed measuring mode, a green speed algorithm in operating on device 10 provides a green speed rating. Therein, first, the force imparted by plunger 702 is calibrated such that a golf ball struck by plunger 702 during operation the green speed algorithm will travel a preset distance, say 8 to 9 feet, on a tournament-ready green. For a benchmark, this preset distance is defined to be a medium speed rating. This first step may be done in an initial calibration mode. Then, the plunger is set to putt the golf ball by device 10 for measurement. Next, the ball is hit and its travelled distance is calculated by device 10. If the travelled distance is calculated to be more than the preset distance, then the green speed algorithm indicates that the green has a higher speed rating than medium. For example, depending on the value of the travelled distance, the speed rating may be fast (e.g. for a distance between 10 to 11 feet for a putt expected to travel 8-9 feet) and very fast (e.g. for a distance of more than 11 feet for a putt expected to travel 8-9 feet). If the travelled distance is calculated to be less than the preset distance, then the green speed algorithm indicates that the green has a lower speed rating than medium. Depending on the value of the travelled distance, the speed rating may be slow (e.g. for a distance between 6 to 7 feet for a putt expected to travel 8 to 9 feet) and very slow (e.g. for a distance of less than 6 feet for a putt expected to travel 8 to 9 feet). An appropriate text or icon display is generated for the green speed and displayed on display 24 by the green speed algorithm. In order to calculate the distance, green speed algorithm may use Equation 2 to calculate the estimated distance covered by the golf ball, and then compare the estimated distance against an internally stored table of distance values providing a green speed rating for an estimated distance. For example, a version of Table 1 may be stored and used by the green speed algorithm:

TABLE 1
Tournament Green Speeds

| Estimated Distance (feet) | Green Speed Level |
|---|---|
| 11 or more | Very Fast |
| 10-11 | Fast |
| 9-10 | Semi-Fast |
| 8-9 | Medium |
| 7-8 | Semi-Slow |
| 6-7 | Slow |
| 6 or less | Very slow |

For the above green speed algorithm, the distance of 8-9 feet had been identified as a medium putt for a green which is prepared for a tournament. It will be appreciated that the meaning of “medium” for a distance of 8-9 feet may not be applicable for greens which are not prepared for a tournament. For example, for a recreational golf course and its greens, a “medium” distance for a putt may be 6-7 feet. As such, the green speed algorithm further allows different scales to be used for different types of greens. In particular, in the green speed algorithm, initially the golfer is prompted to selected a condition level for the green, e.g. “recreational” or “tournanent”. After the condition level is selected and a putt launched by ball launcher 700 is measured, the measured distance is compared against a table of distances and green speeds associated with the selected green condition level. For example, for the “tournament” condition level, the values of Table 1 may be used. For the “recreational” condition level, the values of Table 2 may be used:

TABLE 2
Recreational Green Speeds

| Estimated Distance (feet) | Green Speed Level |
|---|---|
| 9 or more | Very Fast |
| 8-9 | Fast |
| 7-8 | Semi-Fast |
| 6-7 | Medium |
| 5-6 | Semi-Slow |
| 4-5 | Slow |
| 4 or less | Very slow |

It will be appreciated that in other embodiments, additional tables and settings may be used and other values in the tables may be used, as appropriate.

It will further be appreciated that although the embodiment is related to measuring and estimating the distance traveled by a golf ball, other embodiments may incorporate features and concepts of the described embodiment to estimate the distance, velocity and force of other objects, whether they be in the sporting realm or other measurement domains. Other embodiments may provide the same types of calculations for any sporting activity where a projectile is launched, putted, thrown, kicked, shot or otherwise propelled by a participant.

Although the invention has been described with reference to certain specific embodiments, various modifications thereof will be apparent to those skilled in the art without departing from the scope of the invention as outlined in the claims appended hereto.

We claim:

1. A portable device for measuring aspects of a moving golf ball, producing calculations from events detected on said device, said device comprising:
a set of detectors located on at least one side of said device in a spaced relationship for detecting movement of said golf ball across said device;
a display;
a set of input keys;
a microprocessor in said device controlling operation of said set of detectors, said display and said input keys; and
software operating on said microprocessor for controlling operation of said microprocessor and for producing said calculations based on data received from said set of detectors and said input keys, said calculations including: a calculation producing an estimated distance travelled by said golf ball, a calculation producing an estimated force imparted on said golf ball and a calibration of said estimated distance using a measured distance of said golf ball compared against said estimated distance.

2. The portable device for measuring aspects of said golf ball as claimed in claim 1, wherein
said calibration of said estimated distance is a friction calibration for a green upon which said golf ball is putted.

3. The portable device for measuring aspects of said golf ball as claimed in claim 2, wherein
said software further provides a slope calibration of said estimated distance based on a slope factor associated with said green upon which said golf ball is putted.

4. The portable device for measuring aspects of said golf ball as claimed in claim 3, wherein
said software further provides a consistency mode allowing a plurality of
successive golf putts to be measured and compared.

5. The portable device for measuring aspects of said golf ball as claimed in claim 4, wherein
said software further determines a green speed of said green, based on a distance estimated by said device which is travelled by said golf ball when putted across said device with a predefined force.

6. The portable device for measuring aspects of said golf ball as claimed in claim 5, wherein said device further comprises a putting module to selectively impart on said golf ball said predefined force.

7. The portable device for measuring aspects of said golf ball as claimed in claim 6, wherein a selectable condition of said green is provided to said software before said green speed is determined.

8. The portable device for measuring aspects of said golf ball as claimed in claim 7, wherein said calculation producing said estimated distance travelled by said golf ball utilizes said slope calibration, said friction calibration, a calculated speed of said golf ball and a gravity co-efficient.

9. The portable device for measuring aspects of said golf ball as claimed in claim 8, wherein said calculated speed utilizes time readings provided from at least two detectors of said plurality of detectors operating when said golf ball is putted across said device.

10. The portable device for measuring aspects of golf ball as claimed in claim 1, wherein said device is adapted to detect said golf ball moving by said device either from left to right or from night to left.

11. A portable device for measuring aspects of a sporting activity, producing calculations from events detected on said device, said device comprising:
a set of detectors located on at least one side of said device in a spaced relationship for detecting movement of a projectile associated with said sporting activity across said device;
a display;
a set of input keys;
a microprocessor in said device controlling operation of said set of detectors, said display and said input keys; and
software operating on said microprocessor for controlling operation of said microprocessor and for producing said calculations based on data received from said set of detectors and said input keys, said calculations including: a calculation producing an estimated distance travelled by said projectile, a calculation producing an estimated force imparted on said projectile and a calibration of said estimated distance using a measured distance of said projectile compared against said estimated distance.
